(19) United States
(12) Patent Application Publication
(10) Pub. No.: US 2015/0074333 A1
(43) Pub. Date: Mar. 12, 2015

(54) MEMORY CONTROLLER AND MEMORY SYSTEM

(71) Applicant: Kabushiki Kaisha Toshiba, Minato-ku (JP)

(72) Inventors: Hiroshi YAO, Yokohama-shi (JP); Toshikatsu HIDA, Yokohama-shi (JP); Arata MIYAMOTO, Ota-ku (JP)

(73) Assignee: Kabushiki Kaisha Toshiba, Minato-ku (JP)

(21) Appl. No.: 14/197,469

(22) Filed: Mar. 5, 2014

Related U.S. Application Data
(60) Provisional application No. 61/874,425, filed on Sep. 6, 2013.

(51) Int. Cl. G06F 12/02

(52) U.S. Cl. CPC G06F 12/0246
USPC 711/103

(57) ABSTRACT

According to an embodiment, an access controller refers to state information upon an erase operation, causes the erase operation to be performed on all the collection of physical blocks included in a first logical block, and causes the erase operation to be performed on a part of the collection of physical blocks included in a second logical block and does not causes the erase operation to be performed on rest of the collection of the physical blocks in the second logical block.

### CROSS-REFERENCE TO RELATED APPLICATIONS

This application is based upon and claims the benefit of priority from U.S. Provisional Patent Application No. 61/874,425, filed on Sep. 6, 2013; the entire contents of which are incorporated herein by reference.

### FIELD

Embodiments described herein relate generally to a memory controller and a memory system that control nonvolatile semiconductor memory.

### BACKGROUND

In a storage that uses flash memory, data transfer performance is improved by mounting a plurality of memory chips, and driving the plurality of memory chips in parallel. Physical blocks are collected from the respective memory chips, and a virtual block called a logical block is constructed from the collected plurality of physical blocks, and the constructed logical block is used as a managing unit of erase, read, write and the like.

In the flash memory, since memory cells wear out as erasing of blocks are performed, a wear leveling that smoothes a number of times of erasing of blocks is performed. In a case where the logical block is configured, since erasing is performed in the logical block units, the physical blocks within the logical block are at the same number of times of erasing. Accordingly, the number of times of erasing is smoothed in the physical block units if the number of times of erasing in the logical block units is smoothed.

However, in reality, since there is a reliability variation among the physical blocks, an error rate of data error correction may not be the same between the physical blocks having the same number of times of erasing. Especially in a case where the reliability variation is large among memory chips, a physical block included in a memory chip with low reliability and a physical block included in a memory chip with high reliability are mixedly present in the logical block, whereby the error rate differs among the physical blocks within the logical block. Due to this, a possibility of exceeding an error correction capacity of the error correction becomes high at an earlier stage for the physical blocks with low reliability and high error rate, and an entire device had to be regarded as out of service despite sufficiency in life of the physical blocks with high reliability and low error rate.

### BRIEF DESCRIPTION OF THE DRAWINGS

FIG. 1 is a functional block diagram illustrating an internal configuration of a memory system;

FIG. 2 is a diagram illustrating an example of constructing a logical block from nonvolatile semiconductor memory including a plurality of memory chips and a plurality of planes;

FIG. 3 is a diagram illustrating a state transition of the logical block;

FIG. 4 is a diagram illustrating a full block and a partial block;

FIG. 5 is a diagram illustrating a management procedure of life information in a case of using a remaining number of times of erasing possible;

FIG. 6 is a flow chart illustrating an allocating procedure of the logical block of a first embodiment;

FIG. 7 is a diagram illustrating a management procedure of life information in a case of using a remaining number of times of rest;

FIG. 8A and FIG. 8B are a diagram illustrating an effect of life extension in the first embodiment;

FIG. 9 is a diagram illustrating a management procedure of life information in a case of using an average number of error bit;

FIG. 10 is a flow chart illustrating an allocating procedure of the logical block of a second embodiment;

FIG. 11 is a conceptual diagram illustrating a management of logical blocks depending on purposes of allocation; and

FIG. 12 is a flow chart illustrating an allocating procedure of the logical block of a third embodiment.

### DETAILED DESCRIPTION

According to an embodiment, a nonvolatile semiconductor memory includes a plurality of memory chips, each of the memory chips includes a plurality of physical blocks, and the physical block is a unit of erase operation. A memory controller controls the nonvolatile semiconductor memory. The memory controller includes a block manager and an access controller. The block manager manages state information of the plurality of logical blocks. The logical block is a collection of physical blocks from the plurality of memory chips. The state information includes information indicating which of a first state and a second state a logical block is in. The access controller controls the erase operation to the logical blocks. The access controller refers to the state information upon the erase operation, causes the erase operation to be performed on all the collection of physical blocks included in a first logical block, the first logical block being the logical block in the first state, and causes the erase operation to be performed on a part of the collection of physical blocks included in a second logical block and does not cause the erase operation to be performed on rest of the collection of the physical blocks, the second logical block being the logical block in the second state.

Hereafter a memory controller and a memory system according to embodiments will be described in detail with reference to the drawings. Note that these embodiments do not limit the present invention.

### First Embodiment

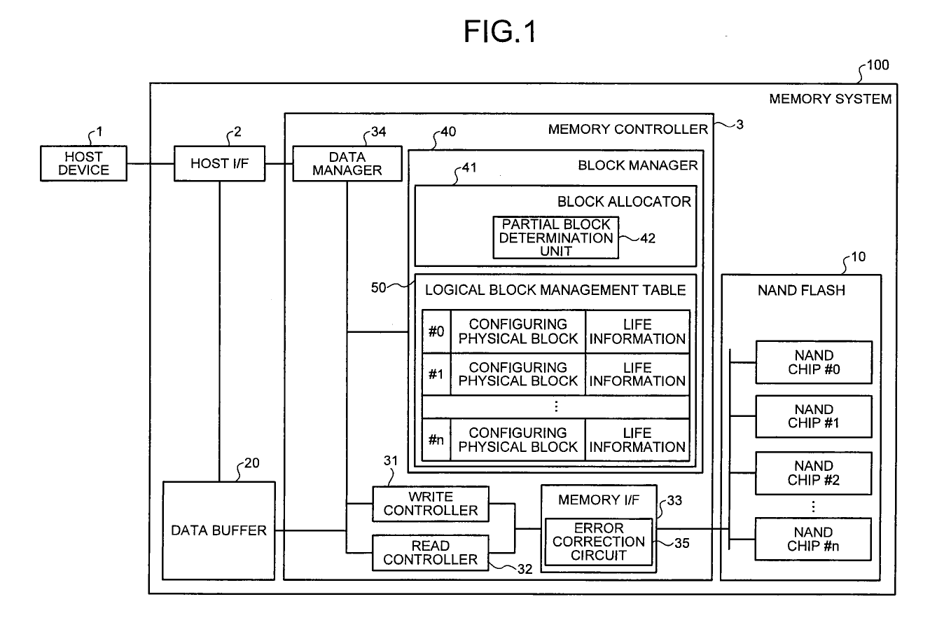

FIG. 1 illustrates a configurational example of a memory system 100. The memory system 100 is connected to a host device (hereafter abbreviated as host) 1 via a host interface 2, and functions as an external storage device of the host 1. The host 1 is for example a personal computer, cell phone, imaging device, and the like.

The memory system 100 includes the host I/F 2, a NAND flash 10 (hereafter abbreviated as NAND) as nonvolatile semiconductor memory, a memory controller 3, and a data buffer 20. The memory controller 3 is provided with a write controller 31, a read controller 32, a memory interface 33, a data manager 34 and a block manager 40. The block manager 40 is provided with a block allocator 41, a partial block determination unit 42, and a logical block managing table 50. The write controller 31, the read controller 32, and the block allocator 41 function as an access controller. Notably, as the nonvolatile semiconductor memory, memories other than the NAND flash may be used. For example, memories such as three-dimensional laminate type NAND flash memory, RERAM (resistance random access memory), FERAM (Ferroelectric Random Access Memory) and the like may be used.

The NAND 10 stores user data sent from the host 1, management information of the memory system 100, system data and the like. The NAND 10 includes a memory cell array in which a plurality of memory cells is arrayed in a matrix. Each memory cell may be capable of multilevel storage by using an upper page and a lower page. The NAND 10 is configured of a plurality of memory chips #0 to #n, and each memory chip #0 to #n is configured by arranging a plurality of physical blocks being units of data erasing. Further, in the NAND 10, data write and data read are performed for each physical page. A physical block is configured of a plurality of physical pages.

The host I/F 2 receives commands such as a read command and a write command from the host 1 via a communication interface such as SATA (Serial Advanced Technology Attachment), a SAS (Serial Attached SCSI) and the like. An address of data, size, data and the like to be transferred by the command is added to the command. When a command is received from the host 1, the host I/F 2 allocates necessary buffer region on the data buffer 20, and notifies the command to the memory controller 3.

The data buffer 20 temporarily stores data transferred to and from the host 1. As the data buffer 20, for example, SRAM (Static Random Access Memory), or DRAM (Dynamic Random Access Memory) is used.

The memory controller 3 performs processings such as reading and writing on the NAND 10 according to commands notified from the host I/F 2. Further, the memory controller 3 performs storage position management of managing positions where the data is to be stored in the NAND 10, and block management of managing which blocks are to be used to store the data.

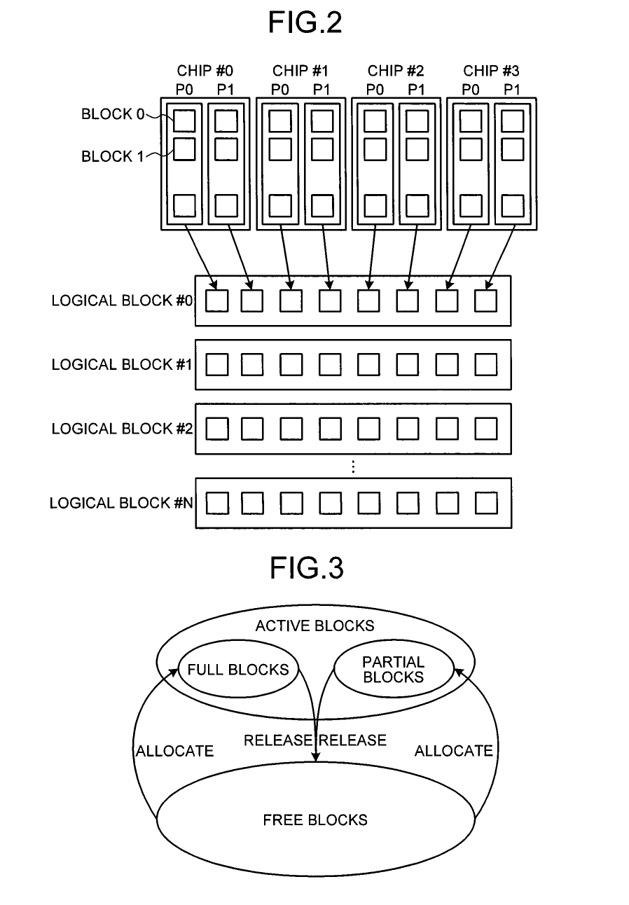

In the memory system 100, logical blocks that are virtual blocks are used as managing units of the blocks. A logical block is configured by gathering physical blocks from the plurality of memory chips #0 to #n. FIG. 2 illustrates a configurational example of the logical blocks. In this example, a memory chip number is four, and each of memory chips chip #0 to chip #3 is divided into two regions (districts), namely a plane p0 and a plane p1. The plane p0 and the plane p1 respectively include a plurality of physical blocks BLK. The plane p0 and the plane p1 have peripheral circuits (for example, row decoder, column decoder, page buffer, data cache and the like) that are independent from one another, and can perform erase/write/read at the same time. In the example of FIG. 2, the logical block combines the physical blocks so that chip parallelizing and plane parallelizing can be performed. In FIG. 2, since the memory chip number is four and a plane number is two, a logical block is configured by a maximum of eight pieces of physical blocks BLK.

Notably, the physical blocks include defective blocks that do not operate normally due to various causes and thus cannot be used (hereafter referred to as bad blocks) and normal blocks that operate normally and thus can be used, and a logical block is constructed of the normal blocks other than the bad blocks. The bad block may occur due to congenital causes at the production stage, and may occur due to acquired causes during the use of the NAND 10, for example, during data read or during data write.

The states of each logical block include two states of an active state and a free state. A logical block in which valid data is recorded is referred to as an active block. A logical block where valid data is not recorded and that is reusable after being erased is referred to as a free block. Only invalid data is stored in the free block. FIG. 3 illustrates a state transition of respective logical blocks. When a new logical block becomes necessary for recording data, a logical block is allocated from a set of free blocks, and an allocated logical block transitions to an active block. After when data is recorded in the active block up to its capacity, data in which new data is rewritten to the same logical address from the host 1, and data that is copied to another block for garbage collection become invalid data. As a result, a block that has been confirmed as that the valid data within the active block has become 0 is released for reuse, and transitions from being the active block to the free block.

In the embodiment, two types of state of the active blocks, namely a full block and a partial block, are further defined. The full block is a logical block that erases all of the physical blocks configuring the logical block and records new data in all of the physical blocks upon allocating a free block as an active block to newly record data. Contrary to this, a partial block handles a part of the physical blocks among the physical blocks configuring the logical block as preserved physical blocks. Erasing and writing are not performed on a preserved physical block. That is the preserved physical block is a physical block to which rest has been given during a certain period. The preserved physical block is restricted of an erasing operation. Accordingly, in the partial block, physical blocks other than the preserved physical block are erased, and data is recorded in the erased physical blocks. The preserved physical block is hereafter referred also as a preserved block.

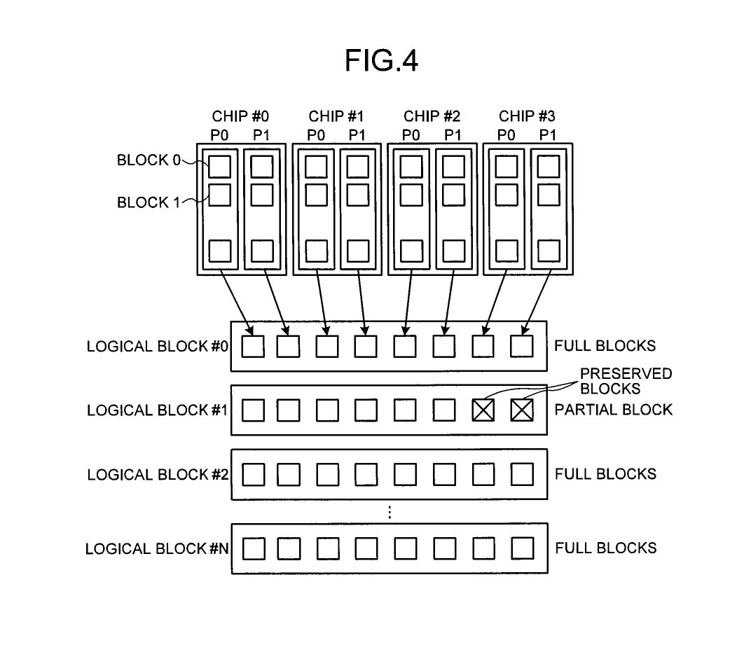

FIG. 4 illustrates a configuration of the partial blocks and the full blocks. A logical block #0, a logical block #2, and a logical block #N are full blocks. A logical block #1 is an example of a partial block that has two physical blocks belonging to a Chip #3 among its eight physical blocks as preserved blocks.

In FIG. 1, the data manager 34 performs the storage position management of managing which position on the NAND 10 data is going to be stored. The data manager 34 includes an address translation table that manages a correspondence of logical addresses given from the host 1 and physical positions on the NAND 10, and performs reallocation of data in the NAND 10 such as garbage collection, compaction and the like according to a used state of blocks in the NAND. In the reallocation of data in the NAND 10, free blocks are released and reclaimed by gathering valid data within a plurality of blocks including invalid data and writing gathered valid data in a different block.

The read controller 32 performs a read process from the NAND 10 according to control of the memory controller 3. The read controller 32 acquires a physical position on the NAND 10 corresponding to a logical address of read data from an address translation table managed by the data manager 34, and performs the read process by notifying the acquired physical position to the memory I/F 33.

The write controller 31 performs a write process from the NAND 10 according to control of the memory controller 3. The write controller 31 acquires position information of a plurality of physical blocks belonging to the logical block to which data is to be written from the block manager 40. The write controller 31 performs the write process by outputting position information of the physical blocks acquired from the block manager 40 and the data read out from the data buffer 20 to the memory I/F 33. The write controller 31 performs a write completion notification to the data manager 34. Due to this, update of the address translation table managed by the data manager 34 is performed.

The memory I/F 33 is a controller that directly controls the NAND according to a control protocol of the NAND 10, and includes an error correction circuit (ECC circuit) 35 and the like. The memory I/F 33 writes the data temporarily stored in the data buffer 20 to the NAND 10 according to the control of the write controller 31 and the like, reads out the data stored in the NAND 10 according to the control of the read controller 32 and the like, and transfers the same to the data buffer 20. The error correction circuit 35 performs an encoding process in an ECC process (error correction process) on the data to be written to the NAND 10, and adds an encoding result to the data. Further, the error correction circuit 35 performs a decoding process (error correction process using an error correction code) in the ECC process on the data read out from the NAND 10.

The block manager 40 performs management of the blocks in the NAND 10, and has the following function (a) to function (c):

(a) To construct the logical block by gathering normal physical blocks from the plurality of memory chips. The block manager 40 constructs the logical block from physical blocks other than the bad blocks for example upon when power is initially turned on in a manufacturing stage. The bad block may occur due to congenital causes at the production stage, and may occur due to acquired causes during the use of the NAND 10 as aforementioned, and the block manager 40 may perform a reconstruction process of the logical block from physical blocks other than the bad blocks even upon using the memory system 100 at a suitable timing such as when the free blocks fall below a predetermined threshold or the like.

(b) To retain management information (state information) of each logical block. The management information is managed by using a logical block managing table 50. The management information includes at least the following information:

Identification information of the plurality of physical blocks configuring the logical block (physical block numbers);

Number of times of erasing (erase count) in logical block units;

Use state (identification information as to being whether an active block or a free block);

In a case of the active block, identification information as to being whether a full block or a partial block; and

In a case of the partial block, identification information of a preserved block within the partial block.

(c) To retain life information indicating variation in a degree of wear of the respective physical blocks in each logical block. This life information (estimated life) is calculated for example by using reliability information of each memory chip and the degree of wear of each physical block. This life information is used for determination by the partial block determination unit 42.

In the first embodiment, a case in which the reliability information (reliability bias) of each memory chip is predeterminedly known upon starting the use of the memory system 100 will be described.

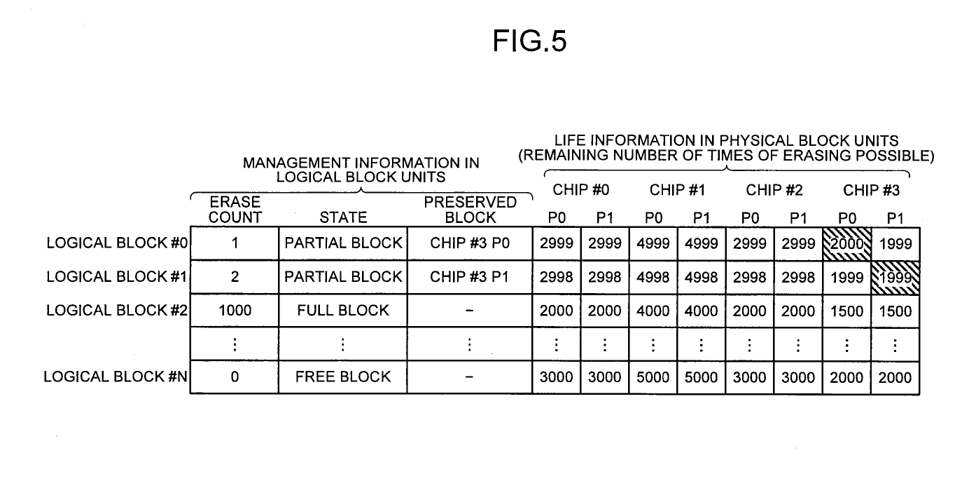

As the life information, for example, as illustrated in FIG. 5, a remaining number of times of erasing (that is) possible Nrce of each physical block is employed. FIG. 5 illustrates a part of the management information managed for each logical block in the logical block managing table 50. In FIG. 5, the number of times of erasing in the logical block units, the identification information as to being whether a full block or a partial block, and the identification information of the preserved block in the partial block as the management information, and the remaining number of times of erasing possible Nrce as the life information are illustrated. In FIG. 5, the remaining number of times of erasing possible Nrce of the eight physical blocks belonging to a memory chip #0 plane p0, a memory chip #0 plane p1, a memory chip #1 plane p0, a memory chip #1 plane p1, a memory chip #2 plane p0, a memory chip #2 plane p1, a memory chip #3 plane p0, and a memory chip #3 plane p1 is recorded for each of the logical blocks.

The remaining number of times of erasing possible Nrce is calculated by subtracting a current number of times of erasing Ne of each physical block from a number of times of erasing possible Nce of the physical block belonging to each memory chip as in the following equation (1).

Nrce=Nce−Ne (1)

In the equation (1), the number of times of erasing possible Nce indicates the reliability information of each memory chip, and the current number of times of erasing Ne indicates the degree of wear of each physical block. The number of times of erasing possible Nce of the physical block is predeterminedly known for each of the memory chips to which the physical block belongs, and the number of times of erasing possible Nce of each physical block comes to be of the same value within the same memory chip in a case where the reconstruction of the logical block or an allocation to the partial block is not performed. An initial value of the number of times of erasing Ne is 0. That is, in a case where the remaining number of times of erasing possible Nrce is employed as the estimated life, the reliability information has the same value for the plurality of physical blocks included in the same memory chip, and the degree of wear is a value that changes according to an erase operation on the respective physical blocks.

The number of times of erasing possible Nce may set the number of times of erasing possible Nce of each memory chip based on a test result upon manufacturing the NAND 10. Further, upon an initial startup during the manufacturing of the memory system 100, erasing, writing, reading, and measurement of the error rate upon the reading may be repeatedly performed on one or more sample blocks of each memory chip, and the reliability information of each memory chip included in each memory chip may be determined based on the measured error rate. The number of times of erasing possible Nce of each memory chip is stored predeterminedly in a specific management region in the NAND 10, for example.

In FIG. 5, the logical block #N illustrates a state of the logical block just after the initialization upon starting the use of the memory system 100. The remaining number of times of erasing possible Nrce of each physical block in the logical block #N is calculated by subtracting the number of times of erasing (=0) from the number of times of erasing possible Nce. In this example, the reliability of the physical blocks belonging to the planes p0, p1 of the memory chip #3 is low. Specifically, the remaining number of times of erasing possible Nrce of the physical blocks belonging to the planes p0, p1 of the memory chip #0 is 3000, the remaining number of times of erasing possible Nrce of the physical blocks belonging to the planes p0, p1 of the memory chip #1 is 5000, the remaining number of times of erasing possible Nrce of the physical blocks belonging to the planes p0, p1 of the memory chip #2 is 3000, and the remaining number of times of erasing possible Nrce of the physical blocks belonging to the planes p0, p1 of the memory chip #3 is 2000.

In FIG. 1, the block allocator 41 includes the partial block determination unit 42. The block allocator 41 allocates a logical block from the free blocks when all of pages of the logical block for writing have been written and a new logical block comes to be in need. The block allocator 41 notifies the allocated free block to the partial block determination unit 42.

The partial block determination unit 42 determines, in connection to a logical block designated by the block allocator 41, whether to allocate it as a partial block or to allocate it as a full block by using the life information. In the partial block determination unit 42, the life information of the designated logical block is acquired from the block manager 40, and determines that it should be allocated as the partial block in a case where there is a difference of a predetermined threshold C1 or more in the life information of the physical blocks in the logical block. In the partial block determination unit 42, the designated logical block is determined as that it should be allocated as the full block in a case where there is the difference in the life information is smaller than the predetermined threshold C1. In the case where it is determined that the logical block should be the partial block, the difference in the life information of the physical blocks in the logical block is made to be small by selecting one or more physical blocks having the short-lived life information as preserved blocks. For example, the physical block having the life information with the shortest life may be selected, or the selection may be made for a plurality of physical blocks in an order of shorter life in the life information.

The block allocator 41 acquires a determination result on determination of whether to regard as the partial block or the full block from the partial block determination unit 42. In a case where the determination result of regarding as the partial block is notified from the partial block determination unit 42, the identification information of the preserved blocks is also notified from the partial block determination unit 42. In the case where the determination is made to use as the full block, the block allocator 41 erases all of the physical blocks in the logical block, and updates the management information and the life information of the logical block. In the case where the determination is made to use as the partial block, the block allocator 41 does not erase the preserved blocks notified from the partial block determination unit 42 but erases the physical blocks in the logical block other than the preserved block, and updates the management information and the life information of the logical block.

In a case where the logical block allocated by the block allocator 41 is a partial block, the write controller 31 does not perform writing in the preserved blocks but performs writing only on the physical blocks other than the preserved blocks. In a case of the full block that is not a partial block, the write controller 31 performs writing on all of the physical blocks in the logical block.

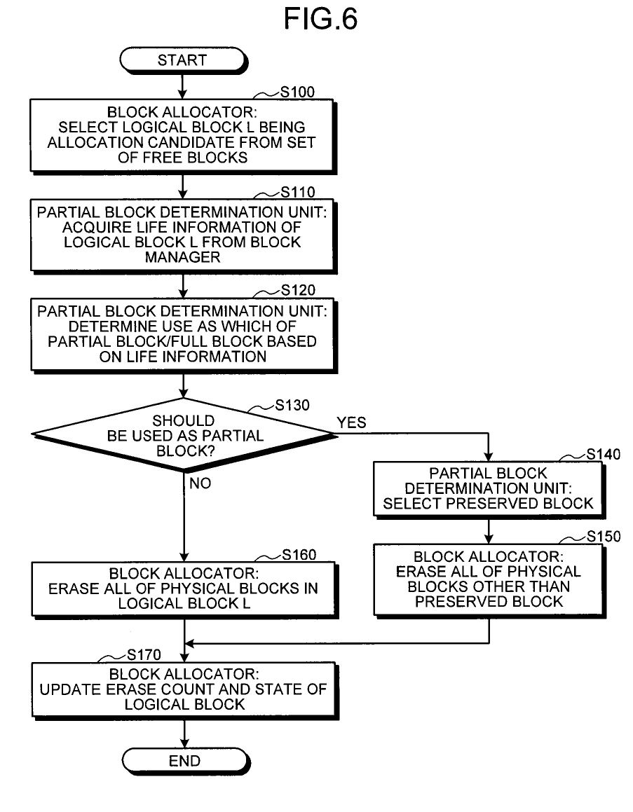

FIG. 6 is a flow chart illustrating a management procedure of the logical blocks. In the flow chart of FIG. 6, a case in which the remaining number of times of erasing possible Nrce is employed as the life information of each physical block will be described. The block allocator 41 selects a logical block L that is an allocation candidate from a set of free blocks, and sends the identification information (for example, the logical block number) of the selected logical block L to the partial block determination unit 42 (step S100). The partial block determination unit 42 acquires the remaining number of times of erasing possible Nrce of each physical block in the logical block L from the block manager 40 (step S110). The partial block determination unit 42 determines whether to use the logical block L as the full block or as the partial block based on the acquired remaining number of times of erasing possible Nrce of each physical block (step S120).

In step S120, the partial block determination unit 42 determines to use the logical block L as the partial block in a case where a difference between a maximum value and a minimum value of the remaining number of times of erasing possible Nrce that the respective physical blocks in the logical block L have is equal to or more than a predetermined threshold C1, and determines to use the logical block L as the full block in a case where the difference is smaller than the predetermined threshold C1.

In the case where the logical block L is determined to be used as the full block (step S130, NO), the partial block determination unit 42 notifies the block allocator 41 that the logical block L should be used as the full block. The block allocator 41 erases all of the physical blocks in the logical block L (step S160), and updates the management information and the reliability information of the logical block L (step S170). The information to be updated includes the number of times of erasing in the logical block units, the use state (the identification information as to being an active block or a free block), the information indicating being the full block, and the remaining number of times of erasing possible Nrce as the life information.

Further, in the case where the logical block L is determined to be used as the partial block (step S130, YES), the partial block determination unit 42 selects the preserved blocks from the logical block L based on the remaining number of times of erasing possible Nrce as the life information (step S140), and notifies the block allocator 41 that the logical block L should be used as the partial block, and the identification information of the preserved blocks.

For example, the partial block determination unit 42 selects one physical block having the life information with the shortest life as a preserved block. In the case where the remaining number of times of erasing possible Nrce as the life information is employed, the partial block determination unit 42 selects the physical block with the shortest life, that is, with the smallest remaining number of times of erasing possible Nrce as the preserved block.

The block allocator 41 erases the physical blocks other than the preserved blocks in the logical block L, and does not erase the preserved blocks (step S150). Further, the block allocator 41 updates the management information and the reliability information of the logical block L (step S170). The information to be updated includes the number of times of erasing in the logical block units, the use state (the identification information as to being an active block or a free block), the information indicating being the partial block, the identification information of the preserved blocks in the partial block, and the remaining number of times of erasing possible Nrce as the life information. Notably, upon writing, if the logical block is a partial block, writing is not performed on the preserved blocks in the partial block, and the writing is performed only on the physical blocks other than the preserved blocks.

In FIG. 5, the logical block #0 illustrates an example of a first-time use. In the logical block #0, the difference of the maximum value and the minimum value of the remaining number of times of erasing possible Nrce of the respective physical blocks is 5000−2000=3000 (see logical block #N). The partial block determination unit 42 determines that this difference (=3000) is larger than the threshold C1, and allocates the logical block #0 as the partial block. The physical block of the plane p0 of the memory chip #3 is selected as the preserved block among of the physical blocks of the planes p0, p1 of the memory chip #3 with the shortest life, that is, with the minimum remaining number of times of erasing possible Nrce of 2000.

Since erase is performed on the physical blocks of the memory chip #3 other than that in the plane p0, the remaining number of times of erasing possible Nrce is decreased by 1.

The logical block #1 illustrates an example of a second-time use. In the logical block #1, the difference of the maximum value and the minimum value of the remaining number of times of erasing possible Nrce of the respective physical blocks is 4999−1999=3000, and is determined as that this difference is larger than the threshold C1, whereby the block is allocated as the partial block. The physical block of the plane p1 of the memory chip #3 with the shortest life, that is, with the minimum remaining number of times of erasing possible Nrce of 1999, is selected as the preserved block. Since erase is performed on the physical blocks of the memory chip #3 other than that in the plane p1, the remaining number of times of erasing possible Nrce is decreased by 1.

The logical block #2 has the number of times of erasing of 1000, and illustrates a state in which rewrite of the respective physical blocks has progressed. In the logical block #2, the difference of the maximum value and the minimum value of the remaining number of times of erasing possible Nrce of the respective physical blocks is 4000−1500=2500, and this difference 2500 is determined as being smaller than the threshold C1. Thus, the logical block #2 is allocated as the full block.

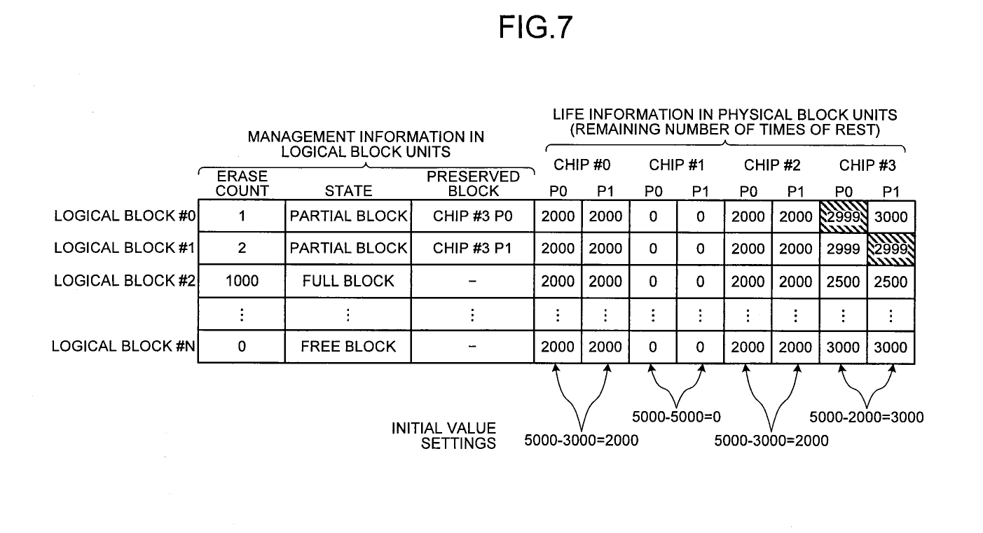

FIG. 7 illustrates an example that employs a remaining number of times of rest (remaining number of times of preservation) Nrre as the life information. An initial value of the remaining number of times of rest Nrre of a physical block is calculated by subtracting the number of times of erasing possible Nce of the physical block belonging to a memory chip from a maximum value Ncemax of the number of times of erasing possible Nce of the physical block to the memory chip as in the following equation (2).

Nrre=Ncemax−Nce (2)

As described above, the number of times of erasing possible Nce of the physical block is known in advance for each memory chip to which the physical block belongs, and the number of times of erasing possible Nce of the physical blocks in the same memory chip comes to be of the same value when the reconstruction of the logical block or the allocation to a partial block is not performed.

The remaining number of times of rest Nrre is decremented by 1 each time the physical block is allocated as a preserved block. Accordingly, the current remaining number of times of rest Nrre is derived by subtracting a current number of times of rest from the initial value of the remaining number of times of rest Nrre.

The initial value of the remaining number of times of rest Nrre expresses the reliability information for each memory chip, and the current number of times of rest expresses the degree of wear of each physical block.

That is, the remaining number of times of rest of the physical block is obtained by using the reliability information of the physical block, and the number of times of erase operation performed on the physical block.

Since the remaining number of times of rest Nrre is obtained based on the number of times of erasing possible Nce of the physical blocks obtained in memory chip units, similar to the remaining number of times of erasing possible Nrce, the value thereof is known at the time of starting the use of the memory system 100.

FIG. 7 illustrates an example of performing the management of the partial blocks and the preserved blocks by using the remaining number of times of rest Nrre in the logical block managing table 50. The initial value of the remaining number of times of rest Nrre is calculated by the above equation (2). As illustrated in the logical block #N of FIG. 5, the maximum value Ncemax of the number of times of erasing possible Nce is 5000. In this example, the initial value of the remaining number of times of rest Nrre of the physical blocks belonging to the planes p0, p1 of the memory chip #0 is 2000, the initial value of the remaining number of times of rest Nrre of the physical blocks belonging to the planes p0, p1 of the memory chip #1 is 0, the initial value of the remaining number of times of rest Nrre of the physical blocks belonging to the planes p0, p1 of the memory chip #2 is 2000, and the initial value of the remaining number of times of rest Nrre of the physical blocks belonging to the planes p0, p1 of the memory chip #3 is 3000.

In FIG. 7, the logical block #0 illustrates the example of the first-time use. In the logical block #0, a difference of the maximum value and the minimum value of the remaining number of times of rest Nrre of the respective physical blocks is 3000−0=3000 (see logical block #N). The partial block determination unit 42 determines that this difference (=3000) is larger than the threshold C1, and allocates the logical block #0 as the partial block. The physical block of the plane p0 of the memory chip #3 is selected as the preserved block among of the physical blocks of the planes p0, p1 of the memory chip #3 with the shortest life, that is, with the maximum remaining rest number Nrre of 3000. Since erase is performed on the physical blocks of the memory chip #3 other than that in the plane p0, the remaining number of times of rest Nrre is decreased by 1.

The logical block #1 illustrates the example of the second-time use. In the logical block #1, the difference of the maximum value and the minimum value of the remaining number of times of rest Nrre of the respective physical blocks is 3000−0=3000, and is determined as that the difference is larger than the threshold C1, whereby the block is allocated as the partial block. The physical block of the plane p1 of the memory chip #3 with the shortest life, that is, with the maximum remaining number of times of rest Nrre of 3000, is selected as the preserved block. Since resting is performed on the physical block in the plane p1 of the memory chip #3, the remaining rest number Nrre is decreased by 1.

The logical block #2 has the number of times of erasing of 1000, and illustrates the state in which the rewrite of the respective physical blocks has progressed. In the logical block #2, the difference of the maximum value and the minimum value of the remaining number of times of rest Nrre of the respective physical blocks is 2500−0=2500, and this difference 2500 is determined as being smaller than the threshold C1. Thus, the logical block #2 is allocated as the full block.

Accordingly in the first embodiment, the physical block belonging to the memory chip with low reliability is used as the partial block that is temporarily unused and put to rest among the physical blocks in the logical block so as to make a difference in the number of times of erasing depending on the reliability, whereby the number of times of erasing of the physical blocks with low reliability in the logical block can be suppressed, and the physical blocks with high reliability can effectively be used up to their number of times of erasing possible before the low-reliability physical blocks are damaged, and it becomes possible to use up all of the physical blocks in the logical block thoroughly through their lives. Further, by making logical blocks to be deficient in turns instead of making all the logical blocks deficient, an operable capability can be maintained, and at the same time a life management of the logical blocks that takes reliability bias among the memory chips into consideration can be performed.

Notably, in the above description, although a free block was allocated as a partial block when the difference in the life information among the respective physical blocks exceeds the threshold, the preserved block may be allocated only to some of the memory chips with low reliability. In this case, a configuration that only retains the life information related to the physical blocks belonging to such memory chips (hereafter referred to as preservation-candidates) is possible. In order to make the remaining number of times of rest of the preservation-candidate memory chips not to be smaller than that of the memory chips other than the preservation-candidates (that is, to prevent from putting them to rest too often), the threshold C1 may be set to be equal to or larger than the remaining number of times of rest of the memory chips other than the preservation-candidates. The minimum value of the remaining number of times of rest is retained at 0. Notably, some of the physical blocks with the life information that is equal to or less than a predetermined value may be regarded as preservation-candidate physical blocks, and estimated lives thereof may be managed instead of managing the life information of the preservation-candidate blocks in the memory chip units.

For example, in a storage having a combination of memory chips similar to FIG. 7, a case will be considered in which only the physical blocks belonging to the memory chip #3 with the lowest reliability are set as the preservation-candidates. In this case, the block manager 40 retains only the life information of the physical blocks in the planes p0, p1 of the memory chip #3. Since the maximum remaining number of times of rest of the memory chips other than the preservation-candidates is 2000 for the memory chip #0 (or #2), by setting the threshold C1=2000, the logical block is no longer allocated as a partial block at a time point when the remaining number of times of rest of the physical blocks belonging to the memory chip #3 becomes 2000.

Further, if the remaining number of times of rest of the preservation-candidate memory chip is set based on the life of the memory chip with the lowest reliability other than the preservation-candidates instead of setting the life of the memory chip with the highest reliability among all of the memory chips as a reference, a value that subtracts the number of times of erasing possible of the respective preservation-candidates from the minimum value of the number of times of erasing possible of the memory chips other than the preservation-candidates may be set as the initial value of the remaining number of times of rest. The threshold C1 is set to 0, and the minimum value of the remaining number of times of rest is set to 0. For example, as mentioned earlier, in the case of setting only the memory chip #3 as the preservation-candidate in FIG. 7, the number of times of erasing possible (=3000) of the memory chip #0 (or #2)−the number of times of erasing possible (=2000) of the memory chip #3=1000 may be set as the initial value of the remaining number of times of rest of the memory chip #3. Due to this, the physical blocks belonging to the memory chip #3 are managed as preserved blocks in the partial block until when the remaining number of times of rest becomes 0.

Accordingly, in a case where preservation-candidate blocks are included in the logical block to be allocated upon the allocation of the logical block from the free block to the active block, the logical block is allocated as a partial block managing the preservation-candidate blocks as preserved blocks until when the remaining number of times of erasing possible or the remaining number of times of rest reaches a threshold, and the logical block is allocated as a full block in which all of the physical blocks including the preservation-candidate blocks are used after when the life information reaches the threshold.

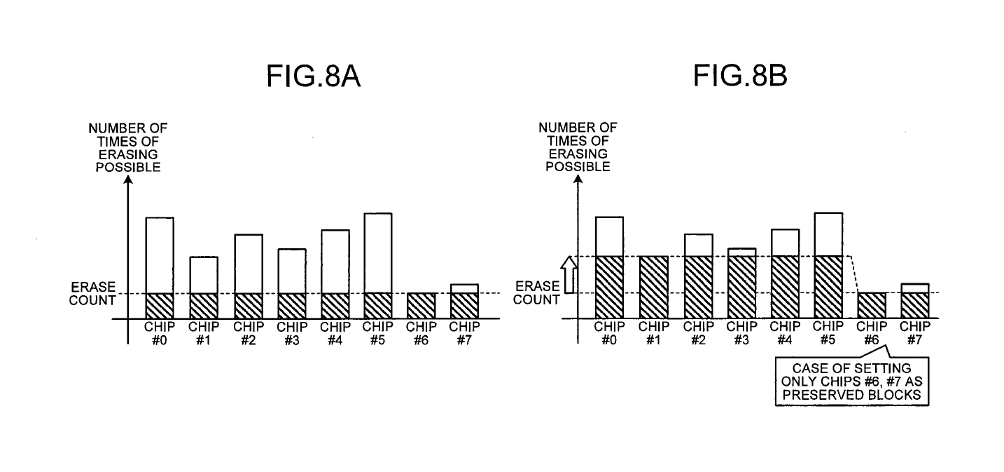

FIG. 8 illustrates an example that configures a logical block by gathering one physical block from each of eight pieces of memory chips #0 to memory chip #7. In FIG. 8A, although there is a bias on reliability (the number of times of erasing possible) of each physical block, the number of times of erasing among the respective physical blocks is the same. Due to this, this logical block becomes unavailable at a time point when the physical block of the memory chip #6 with the lowest reliability ends its life, which as a result the physical blocks with the higher reliability cannot be used thoroughly through their life.

With respect to this, in FIG. 8B, the preserved blocks are allocated only to the two memory chips #6, #7 with low reliability, that is, with small number of times of erasing possible. Due to this, a difference is formed between the number of times of erasing of the physical blocks belonging to the memory chips #6, #7 and the number of times of erasing of the physical blocks belonging to memory chips other than the memory chips #6, #7, whereby it becomes possible to use the physical blocks with the high reliability substantially thoroughly up to their number of times of erasing possible before the low-reliability physical blocks are damaged.

Further, in the embodiment, the reliability (number of times of erasing possible Nce) of each memory chip is estimated in advance in the manufacturing stage, and the threshold C1 is set for the partial block determination; thus, the partial block determination is possible from the beginning of the use of the memory system. Further, in the memory system 100, it is preferable that all of the physical blocks reach their number of times of erasing possible Nce substantially at the same time in the end. Due to this, it becomes possible to use up all of the respective physical blocks in the logical block through their lives if the differences in the remaining number of times of erasing possible among the physical blocks in the logical block can be controlled to be similar.

### Second Embodiment

In the second embodiment, a case in which reliability bias between memory chips is unknown upon beginning use of a memory system 100, reliability information having correlation with wear of physical blocks belonging to each memory chip is employed as life information of the respective physical blocks, and management of partial blocks is performed by dynamically acquiring the reliability information will be described. Specifically, an error correction is performed by an error correction circuit 35 upon reading a block, a bit error rate (BER) thereof is acquired, and an average bit error rate is retained as the life information. As the life information, other than the above, a rate by which correction becomes incapable in the error correction (frame error rate: FER) may be used. Other than the above, if erase time or write time has correlation with the wear of the physical blocks, a value thereof may be employed as the life information.

The embodiment operates such that reliability information dynamically acquired and having correlation with wear is leveled. Hereafter, a specific operation in a case of using the BER as the life information will be described. Upon an initial start of the memory system 100, a block manager 40 initializes the BER of all of physical blocks managed by a logical block managing table 50 to 0. A partial block determination unit 42 determines a partial block in a case where a difference of the maximum value and the minimum value of the BER is greater than a predetermined threshold C2 upon allocating a free block to an active block. The partial block determination unit 42 selects a block with the maximum BER within the partial block as a preserved block. A read controller reads a part of pages of the respective physical blocks after data is written to a logical block (full block or partial block), the BER is acquired by performing the error correction by the error correction circuit 35, and the BER of the respective physical blocks is notified to the block manager 40. The block manager 40 updates the logical block managing table 50 and updates the BER of the respective physical blocks in the logical block to which the writing had been performed.

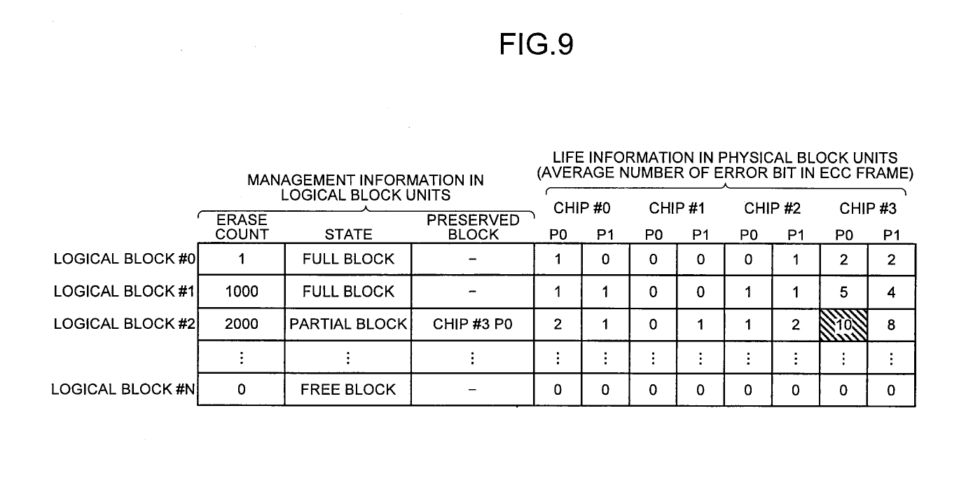

FIG. 9 illustrates an example in which a plurality of sampling pages is read from the respective physical blocks, and an average value of a number of bit error within a plurality of ECC frames that had been read is employed as the reliability information. In this example, the BER is not directly retained because integers are more easily calculated and retained; alternatively, the BER may be retained. In supposing to determine the partial block in a case where there is a difference of 0.1% in the BER, the partial block can be determined when there is a difference of about 9 bits in the number of error bit within the ECC frame in a case where an ECC frame length is 1 KB.

A logical block #N illustrates a state just after the initialization, and an average number of error bit of the respective physical blocks is 0. A logical block #0 and a logical block #1 are allocated as full blocks, since their number of error bit does not reach the threshold C2 (=9). In a logical block #2, since the average number of error bit of the physical block belonging to a plane p0 of a memory chip #3 is 10 and the difference with the physical block belonging to a plane p0 of the memory chip #1 exceeds 9, it is allocated as a partial block. The physical block in the plane p0 of the memory chip #3 with the largest average number of error bit is selected as a physical block with shortest life, and is set as the preserved block.

Accordingly, in the second embodiment, even in the case where the life information is not known in advance, partial block determination can be performed accurately especially when an end of life is nearing, by determining the preserved block that is not to be used while measuring the life information dynamically.

### Third Embodiment

In the third embodiment, an actual capacity of an operable NAND 10 is secured by restricting a partial block number existing simultaneously in a memory system. In a first method, an allocation number of the partial blocks is restricted. In a second method, the partial block is copied and released by copying the valid data into a full block upon a garbage collection to decrease a partial block number.

The first method will be described. A number of allowed partial block is a number of partial block which allocation is allowed simultaneously in a memory system 100, and a number that would ensure that operation can be continued by storing data with a capacity provided to a host 1 in a NAND 10 even when a decrease of the capacity by the partial blocks is subtracted is set thereto. The number of allowed partial block and a total number of partial block at that time are retained and managed by a block manager 40.

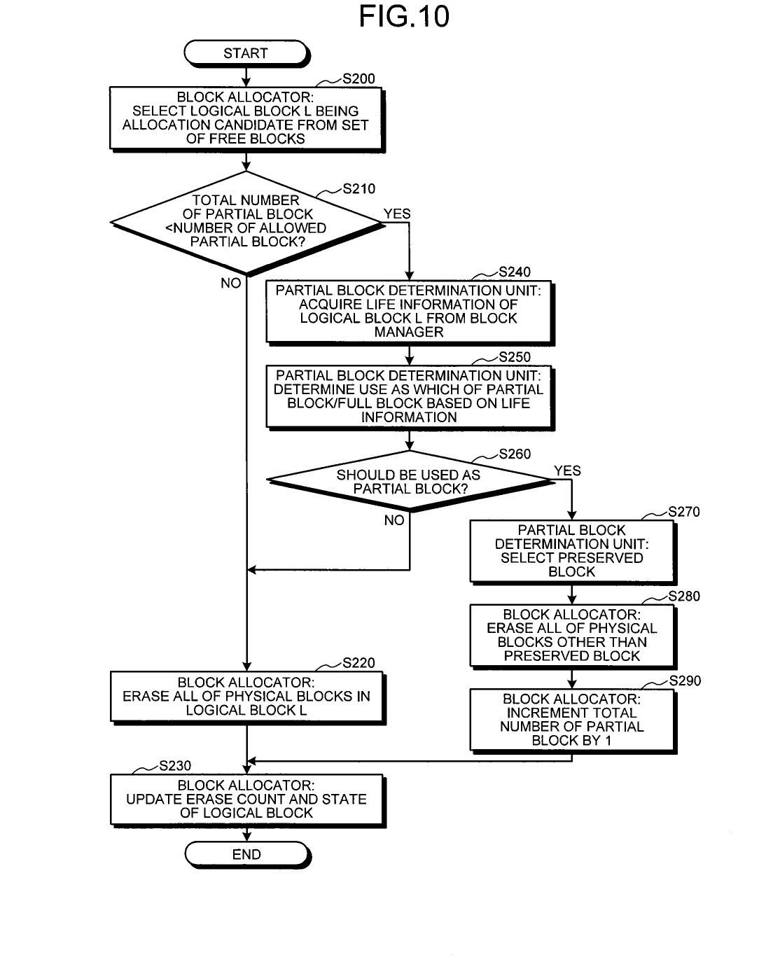

The first method will be described in detail by using FIG. 10. A block allocator 41 selects a logical block L that is an allocation candidate from a set of free blocks (step S200). Next, the block allocator 41 determines whether the total number of partial block is smaller than the number of allowed partial block or not at a current stage (step S210). If the total number of partial block the number of allowed partial block is satisfied and the allocation of the partial block is impossible (step S210: No), the block allocator 41 determines to use this logical block as a full block, and notifies identification information of the logical block L (for example, a logical block number) to the block allocator 41. The block allocator 41 erases all of physical blocks in the logical block L (step S220), and updates management information and reliability information of the logical block L (step S230). The information to be updated includes a number of times of erasing in logical block units, a use state (identification information regarding being an active block or a free block), identification information of being a full block, and life information.

If the total number of partial block<the number of allowed partial block is satisfied and the allocation of the partial block is possible (step S210: Yes), the block allocator 41 sends the identification information of the selected logical block L (for example, the logical block number) to the partial block determination unit 42 (step S240). The partial block determination unit 42 acquires the life information of the logical block L from the block manager 40, and determines which of the full block and the partial block should the logical block L be used as based on the acquired life information of the logical block L (step S250).

In a case where the logical block L is determined as that it should be used as the full block (step S260, NO), the partial block determination unit 42 notifies the block allocator 41 that the logical block L should be used as the full block. The block allocator 41 erases all of physical blocks in the logical block L (step S220), and updates management information and reliability information of the logical block L (step S230).

Further, in a case where the logical block L is determined as that it should be used as the partial block (step S260, YES), the partial block determination unit 42 selects a preserved block from the logical block L based on the life information (step S270), and notifies the block allocator 41 that the logical block L should be used as the partial block, and the identification information of the preserved block. The block allocator 41 erases the physical blocks other than the preserved block in the logical block L, and does not erase the preserved block (step S280). Further, the block allocator 41 increments the total number of partial block by 1 (step S290). Moreover, the block allocator 41 updates the management information and the life information of the logical block L (step S230). The information to be updated includes the number of times of erasing in the logical block units, the use state (the identification information as to being an active block or a free block), the information indicating being the partial block, the identification information of the preserved block in the partial block, and the life information.

Accordingly, in the procedure of FIG. 10, the partial block determination is not performed in the case where the total number of partial block exceeds the number of allowed partial block after having selected the logical block L being the allocation candidate, but allocates the same as the full block, whereby the partial blocks are not set at the same number of the number of allowed partial block or more. Accordingly, the partial blocks can be allocated in a range by which a storage as a whole does not become below a predetermined capacity, and the actual capacity of the operable NAND 10 can be secured.

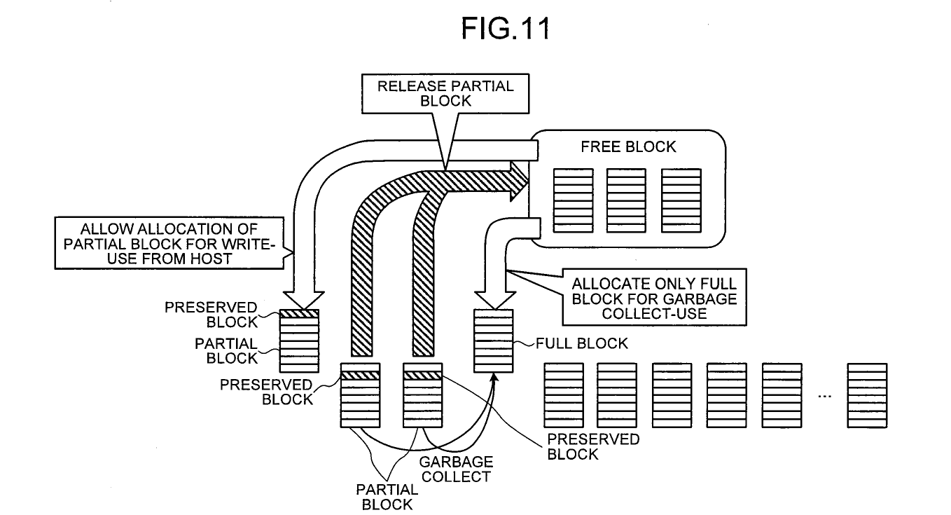

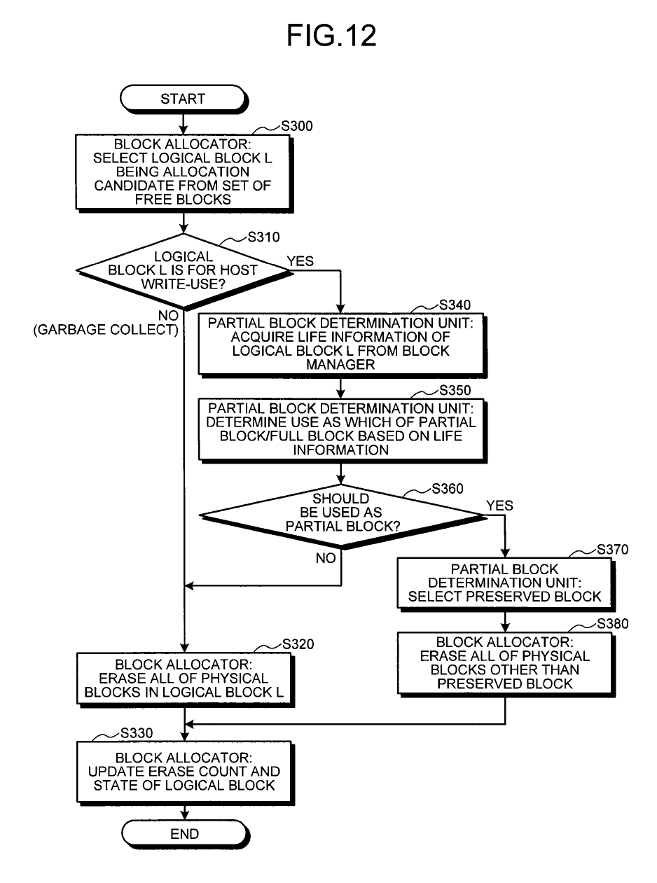

The second method will be described in detail by using FIG. 11 and FIG. 12. In the second method, the increase in the partial blocks is suppressed by allocating a free block as the partial block only when the free block is to be allocated for a specific use that is predeterminedly set. In this embodiment, as illustrated in FIG. 11, a logical block for a host-use for recording data received by a write command from the host 1 and a logical block for a garbage collect-use are separated, and the partial block or the full block is allocated in accordance with the determination result of the partial block determination unit 42 upon the allocation of the host-use logical block, and the full block is allocated regardless of the determination result of the partial block determination unit upon the allocation of the garbage collect-use logical block. That is, in this embodiment, the partial block is used only for the host write use, whereby the partial block number is decreased.

The second method will be described in detail by using FIG. 12. In the second method, the partial block is allocated for the purpose of data write from the host, and the full block is allocated for the purpose of the garbage collection. A block allocator 41 selects a logical block L that is an allocation candidate from a set of free blocks. Next, the block allocator 41 determines whether this logical block L is for the host write-use, or for the garbage collect-use (step S310). In a case where this logical block L is determined as being for the garbage collect-use (step S310, No), the block allocator 41 decides to use this logical block L as the full block, erases all of the physical blocks in the logical block L (step S320), and updates the management information and the reliability information of the logical block L (step S330). The information to be updated includes a number of times of erasing in logical block units, a use state (identification information regarding being an active block or a free block), identification information of being the full block, and life information.

In a case where this logical block L is determined as being for the host write-use (step S310, Yes), the block allocator 41 sends the identification information (for example, the logical block number) of the logical block L to the partial block determination unit 42. The partial block determination unit 42 acquires the life information of the logical block L from the block manager 40 (step S340). The partial block determination unit 42 determines which of the full block and the partial block should the logical block L be used as based on the acquired life information of the logical block L (step S350).

In the case where the logical block L is determined to be used as the full block (step S360, NO), the partial block determination unit 42 notifies the block allocator 41 that the logical block L should be used as the full block. The block allocator 41 erases all of the physical blocks in the logical block L (step S320), and updates the management information and the life information of the logical block L (step 330).

Further, in a case where the logical block L is determined as that it should be used as the partial block (step S360, YES), the partial block determination unit 42 selects a preserved block from the logical block L based on the life information (step S370), and notifies the block allocator 41 that the logical block L should be used as the partial block, and the identification information of the preserved block. The block allocator 41 erases the physical blocks other than the preserved blocks in the logical block L, and does not erase the preserved blocks (step S380). Moreover, the block allocator 41 updates the management information and the life information of the logical block L (step S330). The information to be updated includes the number of times of erasing in the logical block units, the use state (the identification information as to being an active block or a free block), the information indicating being the partial block, the identification information of the preserved block in the partial block, and the life information.

Accordingly, in this embodiment, since the allocation of the partial block is limited to the host write-use, capacity control becomes easy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory controller configured to control a nonvolatile semiconductor memory including a plurality of memory chips, each of the memory chips including a plurality of physical blocks, and the physical block being a unit of erase operation,
the memory controller comprising:
a block manager configured to manage state information of a plurality of logical blocks, each of the logical blocks being a collection of physical blocks from the plurality of memory chips, and the state information including information indicating which of a first state and a second state a logical block is in; and
an access controller configured to control the erase operation to the logical blocks,
wherein the access controller:
refers to the state information upon the erase operation,
causes the erase operation to be performed on all the collection of physical blocks included in a first logical block, the first logical block being the logical block in the first state, and
causes the erase operation to be performed on a part of the collection of physical blocks included in a second logical block and does not cause the erase operation to be performed on rest of the collection of the physical blocks, the second logical block being the logical block in the second state.

2. The memory controller according to claim 1, wherein
upon allocating the logical block from a free block to an active block, the block manager determinates whether the logical block is to be in the first state or the second state, the free block including only invalid data and the active block including valid data.

3. The memory controller according to claim 1, wherein
the access controller further controls a write operation to the logical block,
wherein the access controller:
refers to the state information upon the write operation,
causes the write operation to be performed in all the collection of the physical blocks included in the first logical block, and
causes the write operation to be performed in a part of the collection of the physical blocks included in the second block and does not cause the write operation to be performed in rest of the collection of the physical blocks.

4. The memory controller according to claim 1, wherein the second logical block includes a preserved physical block, and the erase operation to the preserved physical block is restricted.

5. The memory controller according to claim 4, wherein
the block manager sets a physical block with a short estimated life as the preserved physical block in a case where a difference of a maximum value and a minimum value of the estimated life of the physical blocks included in the logical block is equal to or more than a predetermined value.

6. The memory controller according to claim 5, wherein
the estimated life of the physical block is calculated by using reliability information of the physical block and a degree of wear of the physical block.

7. The memory controller according to claim 6, wherein
the reliability information has a same value for the plurality of physical blocks included in a same memory chip, the degree of wear is a value that changes according to the erase operation on each of the physical blocks, and the estimated life of the physical block is calculated by subtracting the degree of wear from the reliability information.

8. The memory controller according to claim 4, wherein
the block manager sets a physical block with a small remaining number of times of rest as the preserved physical block in a case where a difference of a maximum value and a minimum value of the remaining number of times of rest of the physical blocks included in the logical block is equal to or more than a predetermined value.

9. The memory controller according to claim 8, wherein
the remaining number of times of rest of the physical block is calculated by using reliability information of the physical block and a number of times of the erase operation performed on the physical block.

10. The memory controller according to claim 9, wherein the reliability information has a same value for the plurality of physical blocks included in a same memory chip.

11. The memory controller according to claim 4, wherein the block manager sets a physical block with a large bit error rate as the preserved physical block in a case where a difference of a maximum value and a minimum value of the bit error rate of the physical blocks included in the logical block is equal to or more than a predetermined value.

12. The memory controller according to claim 1, wherein the block manager restricts a total number of logical blocks in the second state to be equal to or less than a threshold.

13. The memory controller according to claim 1, wherein the block manager uses the logical block in the first state for a garbage collection.

14. The memory controller according to claim 1, wherein the block manager uses the logical block in the second state to write data from a host.

15. The memory controller according to claim 4, wherein
the block manager manages the physical block having the estimated life that is equal to or less than a predetermined value as preservation-candidate physical blocks, and
in a case where, upon allocating the logical block from the free block to the active block, the logical block includes the preservation-candidate physical block, the preservation-candidate physical block is allocated as the preserved physical block in the second logical block until an estimated life of the preservation-candidate physical blocks reaches a threshold, and the preservation-candidate physical block is allocated as the physical block in the first logical block after the estimated life of the preservation-candidate physical blocks reached the threshold.

16. The memory controller according to claim 15, wherein the estimated life is the remaining number of times of rest of the respective preservation-candidate blocks, and one of an initial value of the estimated life and the threshold is calculated with lowest reliability information among reliability information of the plurality of memory chips other than the memory chip to which the preservation-candidate blocks belongs as a reference.

17. A memory system comprising:
a nonvolatile semiconductor memory including a plurality of memory chips, each of the memory chips including a plurality of physical blocks, and the physical block being a unit of erase operation; and
a controller configured to control the nonvolatile semiconductor memory,
wherein the controller includes
a block manager configured to manage state information of a plurality of logical blocks, each of the logical blocks being a collection of physical blocks from the plurality of memory chips, and the state information including information indicating which of a first state and a second state a logical block is in; and
an access controller configured to control an erase operation to the logical blocks,
wherein the access controller:
refers to the state information upon the erase operation,
causes the erase operation to be performed on all the collection of physical blocks included in a first logical block, the first logical block being the logical block in the first state, and
causes the erase operation to be performed on a part of the collection of physical blocks included in a second logical block and does not cause the erase operation to be performed on rest of the collection of the physical blocks, the second logical block being the logical block in the second state.

18. The memory system according to claim 17, wherein the second logical block includes a preserved physical block, and the erase operation to the preserved physical block is restricted.

19. The memory system according to claim 18, wherein
the block manager sets a physical block with a short estimated life as the preserved physical block in a case where a difference of a maximum value and a minimum value of the estimated life of the physical blocks included in the logical block is equal to or more than a predetermined value.

20. The memory controller according to claim 18, wherein
the block manager manages the physical block having the estimated life that is equal to or less than a predetermined value as preservation-candidate physical blocks, and
in a case where, upon allocating the logical block from the free block to the active block, the logical block includes the preservation-candidate physical block, the preservation-candidate physical block is allocated as the preserved physical block in the second logical block until an estimated life of the preservation-candidate physical blocks reaches a threshold, and the preservation-candidate physical block is allocated as the physical block in the first logical block after the estimated life of the preservation-candidate physical blocks reached the threshold.
